(19) United States
(12) Patent Application Publication
(10) Pub. No.: US 2010/0290629 A1
(43) Pub. Date: Nov. 18, 2010

(54) STEREO SIGNAL CONVERTER, STEREO SIGNAL INVERTER, AND METHOD THEREFOR

(75) Inventor: Toshiyuki Morii, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/809,154

(22) PCT Filed: Dec. 22, 2008
(86) PCT No.: PCT/JP2008/003893

§ 371 Date: Jun. 18, 2010

(30) Foreign Application Priority Data
Dec. 21, 2007 (JP) 2007-330991
Sep. 30, 2008 (JP) 2008-253636

(51) Int. Cl. H04H 20/88

(52) U.S. Cl. 381/2

(57) ABSTRACT

A stereo signal converter capable of realizing encoding with less redundancy, low bit-rate, and high quality even if the positions of sound sources are different from one another. In this device, a sample difference analyzing section (111) uses the signal in which a right-channel signal is shifted by a sample difference (d) in terms of time and a left-channel signal to compute a sample difference (D) in which the correlation becomes highest. A sample difference value computing section (112) computes a sample difference value (z) (the value to shift the right-channel signal in the current frame) on the basis of the value after the right-channel signal is shifted in the previous frame and the sample difference (D). A sample difference value encoding section (113) encodes the sample difference value (z). A slide section (114) shifts the right-channel signal by the sample difference value (z) in terms of time. A sum difference computing section (115) adds the left-channel signal and the shifted right-channel signal to generate a monaural signal and subtracts the shifted right-channel signal from the left-channel signal to generate a side signal.

### TECHNICAL FIELD

The present invention relates to a stereo signal converting apparatus, stereo signal inverse-converting apparatus and converting and inverse-converting methods used in an encoding apparatus and decoding apparatus that realize stereo speech coding.

### BACKGROUND ART

Speech coding is used for communication applications using narrowband speech of the telephone band (200 Hz to 3.4 kHz). Narrowband speech codec of monaural speech is widely used in communication applications including voice communication through mobile phones, remote conference devices and recent packet networks (e.g. the Internet).

Recently, with broadbandization of communication networks, there is a demand for realization of speech communication and high quality of music, and, to meet this demand, speech communication systems using coding techniques of stereo speech have been developed.

As a method of encoding stereo speech, there is a known conventional method of finding a monaural signal and side signal and encoding these signals, where the monaural signal is a sum of the left channel signal and the right channel signal and where the side signal is the difference between the left channel signal and the right channel signal (see Patent Document 1).

The left channel signal and the right channel signal represent sound heard by human ears, the monaural signal can represent the common part between the left channel signal and the right channel signal, and the side signal can represent the spatial difference between the left channel signal and the right channel signal.

There is a high correlation between the left channel signal and the right channel signal, and, consequently, compared to the case of encoding the left channel signal and right channel signal directly, it is possible to perform more suitable coding in accordance with features of a monaural signal and side signal by encoding the left channel signal and right channel signal converted into the monaural signal and side signal, so that it is possible to realize coding with less redundancy, low bit rate and high quality.

### Patent Document 1: Japanese Patent Application Laid-Open Number 2001-255892

### DISCLOSURE OF INVENTION

### Problems to be Solved by the Invention

However, even if the left channel signal and right channel signal share the same main elements, when the excitation position varies between these signals, the correlation between the left channel signal and the right channel signal at the same time becomes low. Therefore, if the left channel signal and right channel signal are converted into a monaural signal and side signal and encoded simply, when the excitation position varies, the monaural signal and side signal still including redundancy are quantized inefficiently.

It is therefore an object of the present invention to provide a stereo signal converting apparatus, stereo signal inverse-converting apparatus and converting and inverse-converting methods for realizing coding with less redundancy, low bit rate and high quality even if the excitation position varies.

### Means for Solving the Problem

The stereo signal converting apparatus of the present invention employs a configuration having: an analyzing section that analyzes a timing difference at which a correlation between a first channel signal and second channel signal forming a stereo signal is highest; a sliding section that moves the second channel signal temporally based on the timing difference; and a sum and difference calculating section that generates a monaural signal related to a sum of the first channel signal and the temporally-moved second channel signal, and generates a side signal related to a difference between the first channel signal and the temporally-moved second channel signal.

The stereo signal inverse-converting apparatus of the present invention employs a configuration having: a reconstructed signal generating section that generates a reconstructed signal of a first channel signal and a reconstructed signal of a temporally-moved second channel signal, using a reconstructed monaural signal and a reconstructed side signal, the reconstructed monaural signal being acquired by decoding encoded data of a monaural signal related to a sum of the first channel signal and the temporally-moved second channel signal forming a stereo signal, and the reconstructed side signal being acquired by decoding encoded data of a side signal related to a difference between the first channel signal and the temporally-moved second channel signal; and a opposite-sliding section that moves and corrects the reconstructed signal of the temporally-moved second channel signal.

The stereo signal converting method of the present invention includes: an analyzing step of analyzing a timing difference at which a correlation between a first channel signal and second channel signal forming a stereo signal is highest; a sliding step of moving the second channel signal temporally based on the timing difference; and a sum and difference calculating step of generating a monaural signal related to a sum of the first channel signal and the temporally-moved second channel signal, and generating a side signal related to a difference between the first channel signal and the temporally-moved second channel signal.

The stereo signal inverse-converting method of the present invention includes: a reconstructed signal generating step of generating a reconstructed signal of a first channel signal and a reconstructed signal of a temporally-moved second channel signal, using a reconstructed monaural signal and a reconstructed side signal, the reconstructed monaural signal being acquired by decoding encoded data of a monaural signal related to a sum of the first channel signal and the temporally-moved second channel signal forming a stereo signal, and the reconstructed side signal being acquired by decoding encoded data of a side signal related to a difference between the first channel signal and the temporally-moved second channel signal; and a opposite-sliding step of moving and correcting the reconstructed signal of the temporally-moved second channel signal.

### ADVANTAGEOUS EFFECT OF THE INVENTION

According to the present invention, even if the excitation position varies between the left channel signal and the right channel signal, by moving one of these signals temporally and then generating a monaural signal and side signal, it is possible to realize coding with less redundancy, low bit rate and high quality.

### BRIEF DESCRIPTION OF DRAWINGS

FIG. 1 is a block diagram showing the configuration of an encoding apparatus including a stereo signal converting apparatus according to Embodiment 1 of the present invention;

FIG. 2 illustrates process in a sum and difference calculating section of a stereo signal converting apparatus according to Embodiment 1 of the present invention;

FIG. 3 is a block diagram showing the configuration of a decoding apparatus including a stereo signal inverse-converting apparatus according to Embodiment 1 of the present invention;

FIG. 4 illustrates process in a sum and difference calculating section of a stereo signal inverse-converting apparatus according to Embodiment 1 of the present invention;

FIG. 5 illustrates an example of interpolation coefficients stored in an interpolation coefficient storage section of a stereo signal inverse-converting apparatus according to Embodiment 1 of the present invention;

FIG. 6 illustrates results of a demonstration experiment;

FIG. 7 is a block diagram showing the configuration of a decoding apparatus including a stereo signal inverse-converting apparatus according to Embodiment 2 of the present invention; and

FIG. 8 illustrates process in a sum and difference calculating section of a stereo signal inverse-converting apparatus according to Embodiment 2 of the present invention.

### BEST MODE FOR CARRYING OUT THE INVENTION

Embodiments of the present invention will be explained below in detail with reference to the accompanying drawings. Here, example cases will be explained with embodiments where a stereo signal is comprised of two signals of the left channel signal and right channel signal. Also, the left channel signal, right channel signal, monaural signal and side signal are represented by “L,” “R,” “M” and “S,” respectively, and their reconstructed signals are represented by “L′,” “R′,” “M” and “S′,” respectively.

### Embodiment 1

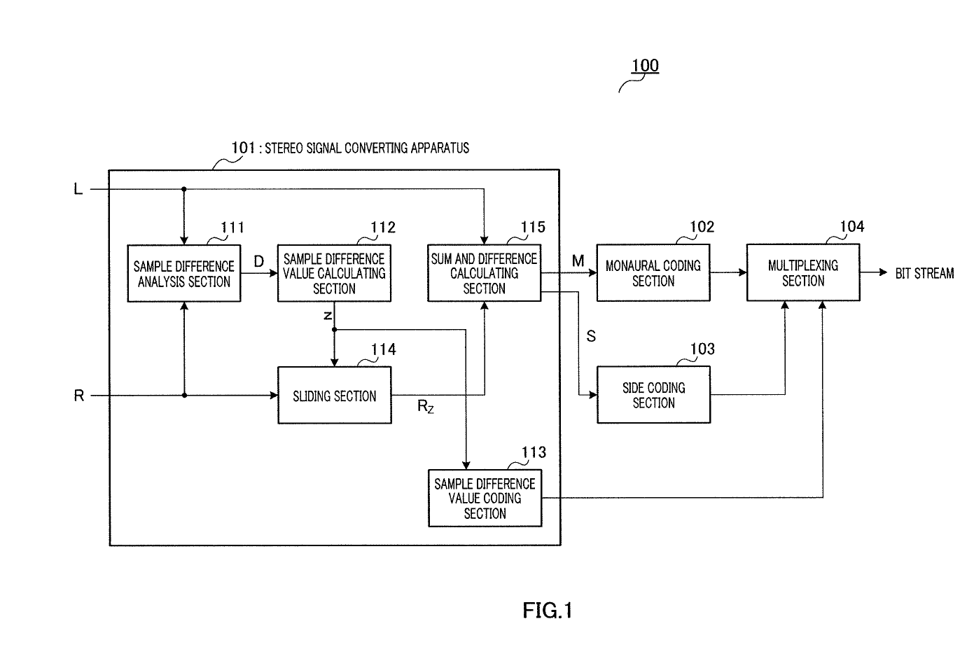

FIG. 1 is a block diagram showing the configuration of an encoding apparatus including a stereo signal converting apparatus according to the present embodiment. Encoding apparatus 100 shown in FIG. 1 is mainly formed with stereo signal converting apparatus 101, monaural coding section 102, side coding section 103 and multiplexing section 104.

Stereo signal converting apparatus 101 temporally moves one of left channel signal L and right channel signal R, and then generates monaural signal M, which is a sum of L and R, and side signal S, which is the difference between L and R. Further, stereo signal converting apparatus 101 outputs monaural signal M to monaural coding section 102 and side signal S to side coding section 103. Further, stereo signal converting apparatus 101 encodes the value by which right channel signal R (hereinafter referred to as “sample difference value,” represented by “z”) was moved, and outputs the result to multiplexing section 104. Here, sample difference value z will be specifically described in explanation of the configuration inside stereo signal converting apparatus 101.

Monaural coding section 102 encodes monaural signal M and output the resulting encoded data to multiplexing section 104. Side coding section 103 encodes side signal S and outputs the resulting encoded data to multiplexing section 104.

Multiplexing section 104 multiplexes the encoded data of monaural signal M, the encoded data of side signal S and the encoded data of sample difference value z, and outputs the resulting bit streams.

Next, the configuration inside stereo signal converting apparatus 101 will be explained. Stereo signal converting apparatus 101 is formed with sample difference analysis section 111, sample difference value calculating section 112, sample difference value coding section 113, sliding section 114 and sum and difference calculating section 115. Also, FIG. 1 shows a case where left channel signal L is fixed. When right channel signal R is fixed, inputs of left channel signal L and right channel signal R are inversed from each other in FIG. 1.

Sample difference analysis section 111 analyzes timing difference D at which the correlation between left channel signal L and right channel signal R is the highest, and outputs timing difference D to sample difference value calculating section 112. For example, according to following equation 1, sample difference analysis section 111 calculates correlation value V_{d} between one frame of input left channel signal L and a signal acquired by moving one frame of input right channel signal R temporally by sample difference d, calculates power C_{d} of right channel signal R at that time and calculates evaluation value E_{d}. Here, in equation 1, Xᵢ^{L} represents the signal value at sample timing i of the left channel signal, and X_{i-d}^{R} represents the signal value at sample timing i of a signal acquired by moving the right channel signal temporally by sample difference d.

$$( Equation 1 )$$

$${V}_{d} = {\sum }_{i} {X}_{i}^{L} \times {X}_{i - d}^{R} \\ {C}_{d} = {\sum }_{i} {X}_{i - d}^{R} \times {X}_{i - d}^{R} \\ {E}_{d} = {V}_{d}^{2} / {C}_{d} \qquad [ 1 ]$$

In equation 1, the correlation between left channel signal L and right channel signal R is higher when E_{d} increases, and therefore sample difference analysis section 111 calculates sample difference D that maximizes this evaluation value E_{d}. For example, when the sampling rate is 16 kHz and the maximum interval between both human ears is assumed around 34 cm, the velocity of sound transmission is 340 m/s, performance can be acquired at ±16 samples (−16 to +15), and therefore sample difference analysis section 111 calculates sample difference D of the highest evaluation value in this range.

Sample difference value calculating section 112 calculates sample difference value z (i.e. the value to move right channel signal R in the current frame) based on the value to move right channel signal R in the previous frame and sample difference D outputted from sample difference analysis section 111. Further, sample difference value calculating section 112 outputs calculated sample difference value z to sample difference value coding section 113 and sliding section 114.

Here, the present embodiment assumes that the variation of sample difference value z in consecutive frames is limited to maximum one sample and sample difference value calculating section 112 performs calculations based on the following rules. That is, the variation is one of −1, 0 and 1.

Rule 1: If sample difference D is equal to sample difference z in the previous frame (i.e. the value by which right channel signal R was moved in the pervious frame), sample difference value z in the current frame adopts the same value as in the previous frame. In this case, the variation is 0.

Rule 2: If sample difference D is greater than sample difference value z in the previous frame, sample difference value z in the current frame increases by one from the previous frame. In this case, the variation is 1.

Rule 3: If sample difference D is less than sample difference value z in the previous frame, sample difference value z in the current frame decreases by one from the previous frame. In this case, the variation is −1.

Sample difference value coding section 113 encodes sample difference value z outputted from sample difference value calculating section 112, and outputs the result to multiplexing section 104. Here, there are the following two methods as a method of encoding a sample difference value.

The first method is to encode sample difference value z directly. For example, when sample difference value z adopts a value between −16 and +15, a numerical value between 0 and 31, which is acquired by adding 16 to the adopted value, can be converted to a five-bit code.

The second method is to encode a difference (i.e. the variation of sample difference value z). The variation of sample difference value z adopts one of −1, 0 and 1, so that a numerical value between 0 and 2, which is acquired by adding 1 to the adopted value, can be converted to a two-bit code. Here, when there is bit error with the second method, it is necessary to note that, once bit error occurs, error propagates for a long time, which makes it difficult to return to the normal condition (i.e. the condition of a signal decoded correctly).

Thus, process of approaching the target delay in units of a small number of samples (e.g. by one sample in the present embodiment), is a reasonable method, because the excitation position in stereo record tends not to change so rapidly.

When the frame length is around 20 ms, even if the excitation position varies, it is sufficiently possible to follow the delay by one-sample changes, and, even when a blank sample occurs upon decoding, it is possible to perform interpolation in an easy manner using the values of samples before and after the blank sample.

Sliding section 114 moves right channel signal R temporally by sample difference value z calculated in sample difference value calculating section 112, and outputs moved right channel signal R_{z} to sum and difference calculating section 115.

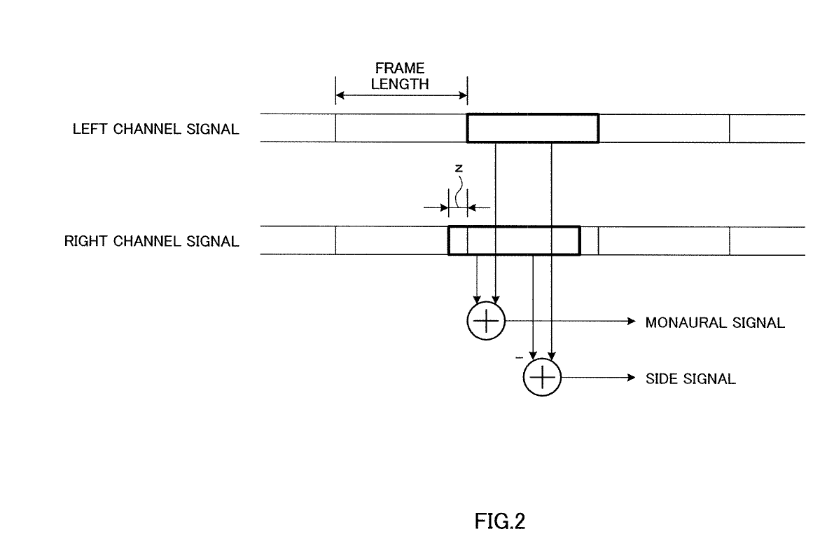

As shown in FIG. 2, sum and difference calculating section 115 generates monaural signal M by adding left channel signal L and moved right channel signal R_{z}, and generates side signal S by subtracting moved right channel signal R_{z} from left channel signal L. Further, sum and difference calculating section 115 outputs monaural signal M to monaural coding section 102 and side signal S to side coding section 103. Equation 2 shows an example of calculations in sum and difference calculating section 115. In equation 2, Xᵢ^{M} represents the signal value at sample timing i of the monaural signal, and Xᵢ^{S} represents the signal value at sample timing i of the side signal.

(Equation 2)

Xᵢ^{M}=(Xᵢ^{L}+X_{i-z}^{R})×0.5

Xᵢ^{S}=(Xᵢ^{L}−X_{i-z}^{R})×0.5 [2]

Thus, with the present embodiment, when the excitation position varies between the left channel signal and the right channel signal, one of these signals is moved temporally, and then a monaural signal and side signal are generated. By this means, compared to the prior art, it is possible to faithfully represent the main elements of the left channel signal and right channel signal by the monaural signal and faithfully represent the spatially different part between the left channel signal and the right channel signal by the side signal, so that it is possible to realize coding with less redundancy, low bit rate and high quality even if the excitation position varies.

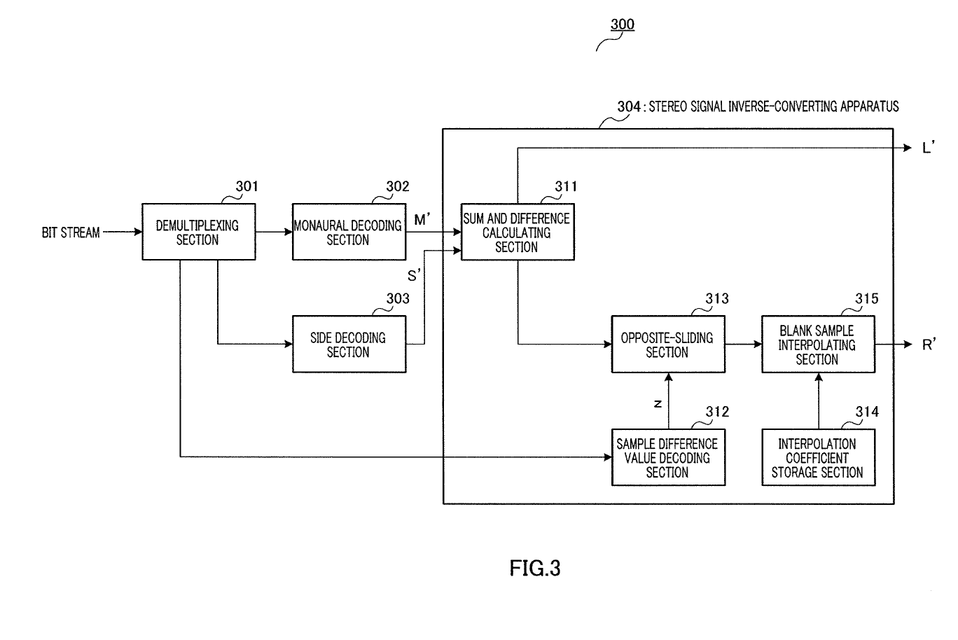

FIG. 3 is a block diagram showing the configuration of a decoding apparatus including a stereo signal inverse-converting apparatus according to the present embodiment. Decoding apparatus 300 shown in FIG. 3 is mainly formed with demultiplexing section 301, monaural decoding section 302, side decoding section 303 and stereo signal inverse-converting apparatus 304.

Demultiplexing section 301 demultiplexes bit streams received in decoding apparatus 300 and outputs the encoded data of monaural signal M, the encoded data of side signal S and the encoded data of sample difference value z to monaural decoding section 302, side decoding section 303 and stereo signal inverse-converting apparatus 304, respectively.

Monaural decoding section 302 decodes the encoded data of monaural signal M and outputs resulting, reconstructed monaural signal M′ to stereo signal inverse-converting apparatus 304. Side decoding section 303 decodes the encoded data of side signal S and outputs resulting, reconstructed side signal S′ to stereo signal inverse-converting apparatus 304.

Stereo signal inverse-converting apparatus 304 provides reconstructed left channel signal L′ and reconstructed right channel signal R′ using the encoded data of sample difference value z, reconstructed monaural signal M′ and reconstructed side signal S′.

Next, the configuration inside stereo signal inverse-converting apparatus 304 will be explained. Stereo signal inverse-converting apparatus 304 is formed with sum and difference calculating section 311, sample difference value decoding section 312, opposite-sliding section 313, interpolation coefficient storage section 314 and blank sample interpolating section 315. Here, FIG. 3 shows a case where reconstructed left channel signal L′ is fixed. When reconstructed right channel signal R′ is fixed, inputs of reconstructed left channel signal L′ and reconstructed right channel signal R′ are inversed from each other in FIG. 3.

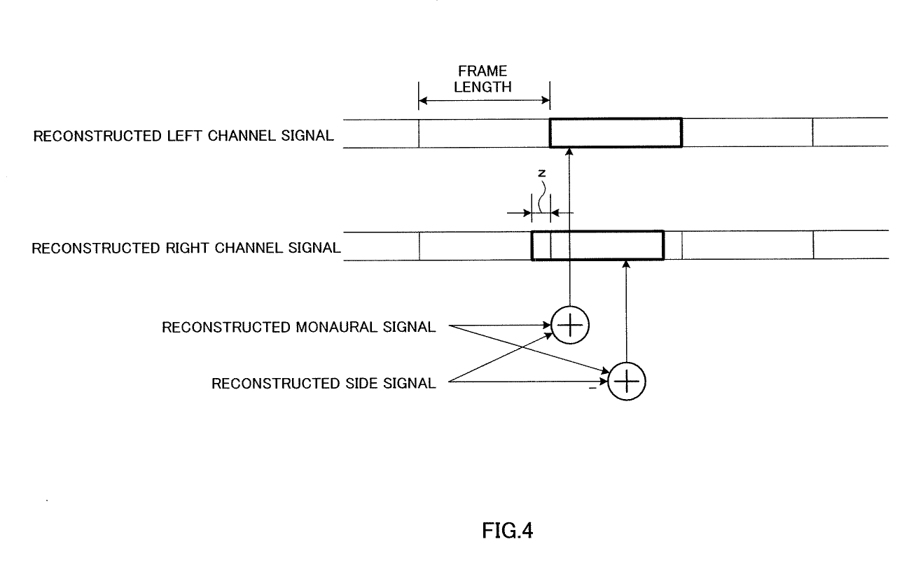

As shown in FIG. 4, sum and difference calculating section 311 calculates reconstructed left channel signal L′ and reconstructed right channel signal R_{z}′ according to following equation 3, using reconstructed monaural signal M′ outputted from monaural decoding section 302 and reconstructed side signal S′ outputted from side decoding section 303. Here, in equation 3, Yᵢ^{M} represents the signal value at sample timing i of the reconstructed monaural signal, Yᵢ^{S} represents the signal value at sample timing i of the reconstructed side signal, Yᵢ^{L} represents the signal value at sample timing i of the reconstructed left channel signal, and Y_{i-z}^{R} represents the signal value at sample timing i of the moved, reconstructed right channel signal.

(Equation 3)

Yᵢ^{L}=Yᵢ^{M}+Yᵢ^{S}

Y_{i-z}^{R}=Yᵢ^{M}−Yᵢ^{S} [3]

Sample difference value decoding section 312 decodes the encoded data of sample difference value z outputted from demultiplexing section 301, and outputs resulting sample difference value z to opposite-sliding section 313.

In opposite sliding section 313, moved, reconstructed right channel signal R_{z}′ is moved by sample difference value z outputted from sample difference value decoding section 312, in the direction opposite to the direction of temporal move in sliding section 114 of stereo signal converting apparatus 101. In other words, in opposite-sliding section 313, moved, reconstructed right channel signal R_{z}′ is moved to temporally match reconstructed left channel signal L′.

Here, when the variation of sample difference value z calculated in sample difference value calculating section 112 is 1, as a result of move in opposite-sliding section 313, one sample of blank area (hereinafter “blank sample”) occurs between the current frame and the pervious frame in a signal sequence of reconstructed right channel signal R′. When a blank sample occurs in the signal sequence of reconstructed right channel signal R′, blank sample interpolating section 315 interpolates the blank sample by interpolation process using coefficient values stored in interpolation coefficient storage section 314 and the values of samples before and after the blank sample, and then outputs reconstructed right channel signal R′. Here, if a blank sample does not occur in the signal sequence of reconstructed right channel signal R′, blank sample interpolating section 315 outputs reconstructed right channel signal R′ as is.

Next, interpolation process in blank sample interpolating section 315 will be explained below in detail using a specific example. With this example, interpolation is performed with five samples before and after a blank sample.

As shown in following equation 4, blank sample interpolating section 315 calculates the value of the blank sample by calculating the linear sum of five samples before and after the blank sample. Here, in equation 4, Yⱼ represents the blank sample, Yⱼ₊, represents five samples before and after the blank sample, and βᵢ represents the interpolation coefficients (fixed values). Also, FIG. 5 shows an example of interpolation coefficients stored in interpolation coefficient storage section 314.

$$( Equation 4 )$$

$${Y}_{j} = {\sum }_{i = - 5}^{- 1} {β}_{i} {Y}_{j + i} + {\sum }_{i = 1}^{5} {β}_{i} {Y}_{j + i} \qquad [ 4 ]$$

Thus, even if a blank sample occurs as a result of moving back a signal in the direction opposite to the direction in which that signal was moved on the coding side, by performing interpolation using the values of samples before and after the blank sample, it is possible to prevent discontinuous abnormal noise from occurring after efficient coding/decoding. Especially, by performing process of approaching the target delay in units of a small number of samples (e.g. by one sample in the present embodiment) on the coding side, it is possible to make the number of blank samples to be interpolated smaller on the decoding side and maintain speech quality of stereo signals.

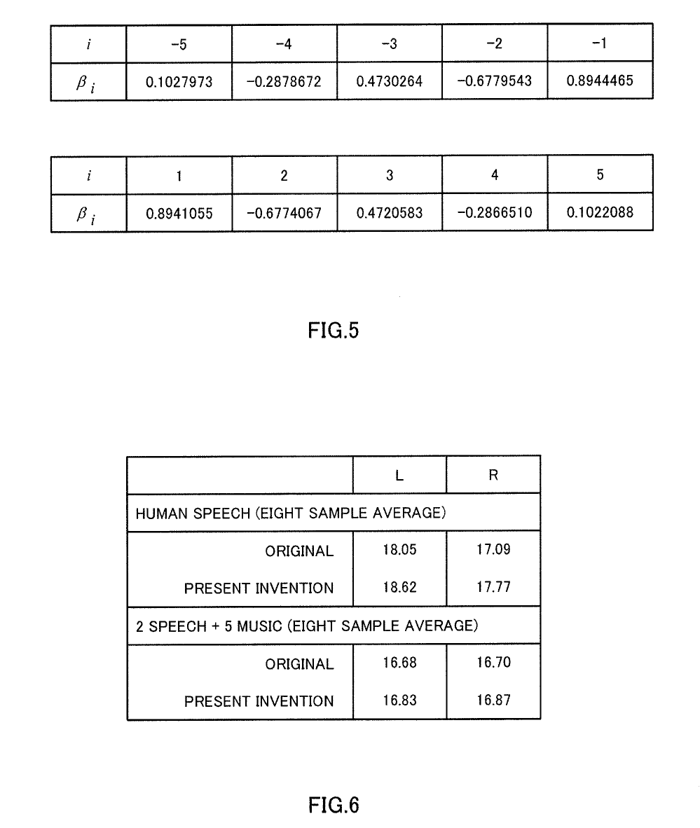

FIG. 6 illustrates results of a demonstration experiment. FIG. 6 shows S/N ratios (of the unit “dB,” which increase when quality is higher) in the case of calculating and encoding/decoding monaural signal M and side signal S from left channel signal L and right channel signal R, and generating reconstructed left channel signal L′ and reconstructed right channel signal R′, according to the conventional method (“original”) and the present invention. Here, in FIG. 6, the S/N ratio of left channel signal L is found from equation 5, and the S/N ratio of right channel signal R is found from equation 6.

$$( Equation 5 )$$

$$\begin{matrix}S \text{/} N ratio of left channel signal = 10 {log}_{10} \frac{{L}^{2}}{{( L - {L}^{′} )}^{2}} \\ ( Equation 6 ) & [ 5 ] \\ S \text{/} N ratio of right channel signal = 10 {log}_{10} \frac{{R}^{2}}{{( R - {R}^{′} )}^{2}} & [ 6 ]\end{matrix}$$

As shown in FIG. 6, the present invention is especially effective in the case where the direction is fixed like human voice, so that it is possible to improve the S/N ratio by 0.6 dB or more than the conventional method. Also, with the present invention, even in the case where the direction is not fixed like music, it is possible to improve the S/N ratio by approximately 0.15 dB more than the conventional method.

As described above, according to the present invention, when the excitation position varies between the left channel signal and the right channel signal, one of these signals is moved temporally and then a monaural signal and side signal are generated, and a time difference element (corresponding to the sample difference value) is encoded separately. By this means, compared to the prior art, it is possible to faithfully represent the main elements of the left channel signal and right channel signal by the monaural signal and faithfully represent the spatially different part between the left channel signal and the right channel signal by the side signal, so that it is possible to realize coding with less redundancy, low bit rate and high quality even if the excitation position varies.

Further, even if a blank sample occurs as a result of moving back a signal in the direction opposite to the direction in which the signal was moved on the coding side, by performing interpolation using the values of samples before and after the blank sample, it is possible to prevent discontinuous abnormal noise from occurring after efficient coding/decoding. Especially, by performing process of approaching the target delay in units of a small number of samples (e.g. by one sample in the present embodiment) on the coding side, it is possible to make the number of blank samples to be interpolated smaller on the decoding side and maintain speech quality of stereo signals

### Embodiment 2

The present embodiment provides an advantage that, when there is an overlap part in a signal changed by a sample difference value (i.e. when data is further written in a position where another data is stored), the decoding apparatus calculates sample values in the overlap part and finds the sample value of the overlap part.

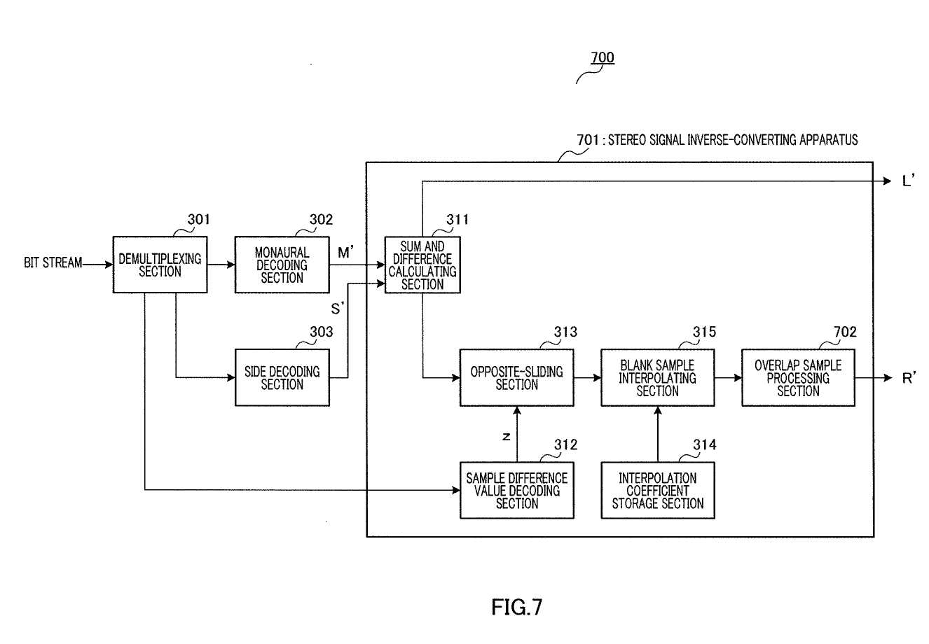

FIG. 7 is a block diagram showing the configuration of decoding apparatus 700 according to Embodiment 2 of the present invention.

Decoding apparatus 700 shown in FIG. 7 replaces stereo signal inverse-converting apparatus 701 with stereo signal inverse-converting apparatus 304 in decoding apparatus 300 according to Embodiment 1 shown in FIG. 3. Also, in FIG. 7, the same components as in FIG. 3 will be assigned the same reference numerals and their explanation will be omitted.

Decoding apparatus 700 shown in FIG. 7 is mainly formed with demultiplexing section 301, monaural decoding section 302, side decoding section 303 and stereo signal inverse-converting apparatus 701.

Monaural decoding section 302 decodes encoded data of monaural signal M and outputs resulting, reconstructed monaural signal M′ to stereo signal inverse-converting apparatus 701. Side decoding section 303 decodes encoded data of side signal S and outputs resulting, reconstructed side signal S′ to stereo signal inverse-converting apparatus 701.

Stereo signal inverse-converting apparatus 701 provides reconstructed left channel signal L′ and reconstructed right channel signal R′ using encoded data of sample difference value z, reconstructed monaural signal M′ and reconstructed side signal S′.

Next, the configuration inside stereo signal inverse-converting apparatus 701 will be explained.

Stereo signal inverse-converting apparatus 701 shown in FIG. 7 adds overlap sample processing section 702 to stereo signal inverse-converting apparatus 304 according to Embodiment 1 shown in FIG. 3. Here, in FIG. 7, the same components as in FIG. 3 will be assigned the same reference numerals and their explanation will be omitted.

Stereo signal inverse-converting apparatus 701 is formed with sum and difference calculating section 311, sample difference value decoding section 312, opposite-sliding section 313, interpolation coefficient storage section 314, blank sample interpolating section 315 and overlap sample processing section 702. Also, FIG. 7 shows a case where reconstructed left channel signal L′ is fixed. When reconstructed right channel signal R′ is fixed, inputs of reconstructed left channel signal L′ and reconstructed right channel signal R′ are inversed from each other in FIG. 7.

When a blank sample occurs in a signal sequence of reconstructed right channel signal R′, blank sample interpolating section 315 interpolates the blank sample by interpolation process using coefficient values stored in interpolation coefficient storage section 314 and the values of samples before and after the blank sample, and then outputs reconstructed right channel signal R′ to overlap sample processing section 702. Here, if a blank sample does not occur in the signal sequence of reconstructed right channel signal R′, blank sample interpolating section 315 outputs reconstructed right channel signal R′ as is to overlap sample processing section 702. Also, interpolation process in blank sample interpolating section 315 is the same as in above Embodiment 1, and therefore explanation will be omitted.

If an overlap occurs in a sample of the signal sequence of reconstructed right channel signal R′ received as input from blank sample interpolating section 315, overlap sample processing section 702 finds the sample value by calculation using a plurality of overlap samples. By this means, overlap sample processing section 702 resolves the overlap in the overlap part. Here, if an overlap does not occur in a sample of the signal sequence of reconstructed right channel signal R′, overlap sample processing section 702 outputs reconstructed right channel signal R′ as is.

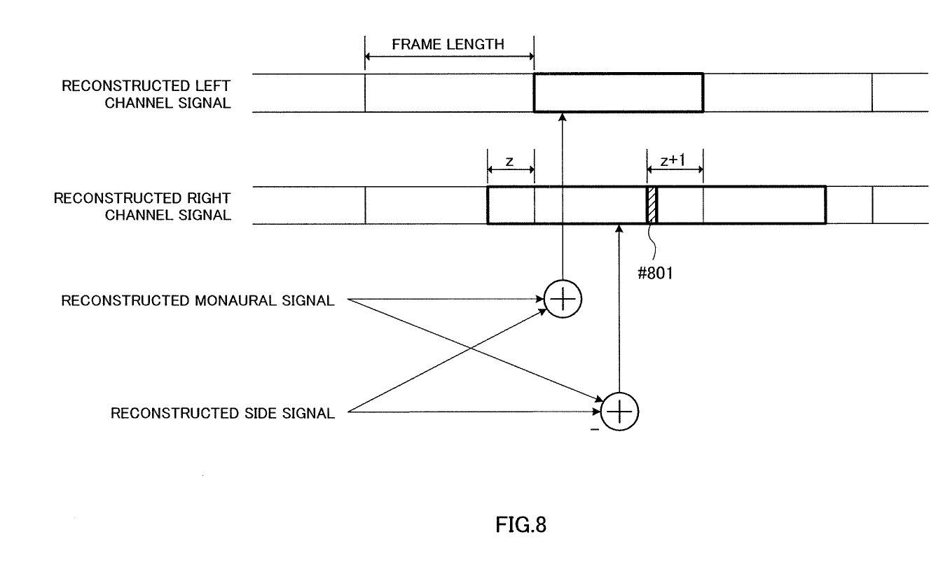

Next, the process of finding the sample value of an overlap part in overlap sample processing section 702 will be explained using a specific example. With this example, as shown in FIG. 8, the sample value of overlap part #801, which occurs when the sample difference value changes to a past value (i.e. from z to z+1), is calculated. FIG. 8 shows a case where there is an overlap of one sample.

Overlap sample processing section 702 calculates the linear sum of the consecutive samples (i.e. overlap samples), according to equation 7.

(Equation 7)

Y_{J}=(Y_{J}^{m}+Y_{O}^{m+1})·0.5 [7]
Yⱼ: overlap sample
Yⱼ^{m}: last sample in m-th frame
Y₀^{m+1}: first sample in (m+1)-th frame

Overlap sample processing section 702 provides reconstructed right channel signal R′ through the above process. Further, reconstructed right channel signal R′ is outputted together with reconstructed left channel signal L′ calculated in sum and difference calculating section 311, to the outside of stereo signal inverse-converting apparatus 701.

The sample value found in overlap sample processing section 702 is calculated based on the values found both in the m-th frame and in the (m+1)-th frame, so that it is possible to calculate a sample value close to the actual value from information of both frames, and suppress discontinuity of sound by overlapping consecutive samples between those frames. Also, according to the present embodiment, it is possible to prevent discontinuous abnormal noise from occurring after efficient coding and decoding, and perform processing such that the sound quality of stereo signals subjected to coding and decoding with high quality does not degrade.

Also, although there may be a case where the sample difference value is equal to or greater than 2, that is, where an overlap of two samples or more occurs, in this case, adjustment is necessary by a triangle window, and so on. As an example, equation 8 shows cases where the sample difference value is 2 (i.e. the number of overlaps is 2) and where the sample difference value is 3 (i.e. the number of overlaps is 3).

$$( Equation 8 )$$

$$when the number of overlaps is 2 , \\ {Y}_{J - 1} = {Y}_{J - 1}^{m} \cdot \frac{2}{3} + {Y}_{0}^{m + 1} \cdot \frac{1}{3} \\ {Y}_{J} = {Y}_{J}^{m} \cdot \frac{1}{3} + {Y}_{1}^{m + 1} \cdot \frac{2}{3} \\ when the number of overlaps is 3 , \\ {Y}_{J - 2} = {Y}_{J - 2}^{m} \cdot 0.25 + {Y}_{0}^{m + 1} \cdot 0.75 \\ {Y}_{J - 1} = {Y}_{J - 1}^{m} \cdot 0.50 + {Y}_{1}^{m + 1} \cdot 0.50 \\ {Y}_{J} = {Y}_{J}^{m} \cdot 0.75 + {Y}_{2}^{m + 1} \cdot 0.25 \qquad [ 8 ]$$

Thus, according to the present embodiment, in addition to the effect in above Embodiment 1, the sample value of an overlap part is found from consecutive samples including the overlap sample, so that it is possible to use information of both frames without waste and suppress an occurrence of perceptual sound discontinuity.

Also, although two stereo signals are expressed by the names “left channel signal” and “right channel signal,” it is equally possible to use more general names such as “first channel signal” and “second channel signal.”

Also, although cases have been described with the above embodiments where the left channel signal of a stereo signal is fixed, according to the present invention, it is equally possible to provide the above effect by fixing the right channel signal. In this case, the left channel signal and the right channel signal in the above embodiments are switched.

Also, although the range of sample difference values is ±16 in the above embodiments, the range of sample difference values is not limited in the present invention. By widening this range, the number of variations to express a delay increases, so that quality becomes high. By contrast, by narrowing this range, it is possible to reduce coding bits.

Also, although the variation of the sample difference value is ±1 sample in the above embodiments, the variation of the sample difference value is not limited in the present invention. Here, the variation of the sample difference value is limited within a range in which interpolation is possible in blank sample interpolating section 315, and the present inventor also verifies that the limit is one or two samples in stereo speech at sampling rate 16 kHz.

Also, although interpolation in blank sample interpolating section 315 is performed with the linear sum of five samples before and after a blank sample in the above embodiments, the number of samples to be used for interpolation is not limited in the present invention. If that number increases, it is possible to further improve the accuracy of interpolation. Here, the inventor verifies with an experiment that the lowest number of samples is five and that, if the number of samples is decreased less than five, the accuracy of interpolation degrades, which causes small abnormal noise. If the number of samples to be used for interpolation is increased excessively, a problem naturally arises that the amount of calculation increases.

Also, although an integral value is used for a sample difference value in the above embodiments, the present invention is not limited to this, and it is equally possible to use a fraction value as a sample difference value. In this case, the fraction value is interpolated and used by, for example, SINC function. By using the fraction value, it is possible to improve the accuracy of time difference. Here, there is a problem that, if the accuracy improves to ½ accuracy, ⅓ accuracy, and so on, the amount of calculations increases. Here, the inventor confirms that, if the sampling rate is 16 kHz, the effect is provided with integer accuracy. Also, the inventor confirms that the accuracy needs to be improved to, for example, ½ accuracy, in the case of 8 kHz sampling.

Also, according to the present invention, without depending on the sampling rate, it is possible to cope with all sampling rates of 8 kHz, 16 kHz, 32 kHz, 44.1 kHz, 48 kHz, and so on. Here, in the case of a sampling rate of 32 kHz or more, it is necessary to perform a search in a much wider range of sample difference values than ±16. Further, in this case, it is possible to interpolate many samples, so that it is possible to increase the variation of a sample difference value.

Also, although cases have been described with the above embodiments where encoded information is transmitted from the encoding side to the decoding side, the present invention is equally effective to a case where encoded information in the encoding side is stored in a storage medium. The present invention is equally effective to a case where audio signals are often accumulated and used in a memory or disk.

Also, although cases have been described with the above embodiments where two channels are used, the number of channels is not limited, and the present invention is equally effective in the case where many channels (e.g. 5.1 channels) are used. In this case, if channels having time differences and correlation with a fixed channel are clarified, the present invention is directly applicable to this case.

Also, although cases have been described with the above embodiments where a monaural signal and side signal are encoded, the present invention is not limited to this, and the present invention is equally effective to a method using only a monaural signal. By using the present invention, it is possible to correct and down-mix a phase difference, so that it is possible to provide a monaural signal of high quality which is substantially equivalent to an excitation.

Also, in the above embodiments, although the equation for converting the left channel signal and right channel signal to a monaural signal and side signal, can be represented by the matrix of following equation 9, the present invention is equally effective in a case where this matrix differs from equation 9. This is because the feature of the present invention of correcting a phase difference little by little and interpolating a blank area that occurs upon the correction, does not depend on features of the above matrix. Therefore, upon converting signals of many channels like 5.1 channels, although the order of matrix becomes much higher and the values become complex, the present invention is equally effective even in this case.

$$( Equation 9 )$$

$$( \begin{matrix}M \\ S\end{matrix} ) = ( \begin{matrix}0.5 & 0.5 \\ 0.5 & - 0.5\end{matrix} ) ( \begin{matrix}L \\ R\end{matrix} ) \qquad [ 9 ]$$

Also, the above explanation is an example of the best mode for carrying out the present invention, and the scope of the present invention is not limited to this. The present invention is applicable to systems in any cases as long as these cases include an encoding apparatus and decoding apparatus.

Also, the encoding apparatus and decoding apparatus according to the present invention can be mounted on a communication terminal apparatus and base station apparatus in a mobile communication system, so that it is possible to provide a communication terminal apparatus, base station apparatus and mobile communication system having the same operational effect as above.

Although a case has been described above with the above embodiments as an example where the present invention is implemented with hardware, the present invention can be implemented with software. For example, by describing the algorithm according to the present invention in a programming language, storing this program in a memory and making the information processing section execute this program, it is possible to implement the same function as the coding apparatus according to the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be regenerated is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2007-330991, filed on Dec. 21, 2007, and Japanese Patent Application No. 2008-253636, filed on Sep. 30, 2008, including the specifications, drawings and abstracts, are incorporated herein by reference in their entireties.

### INDUSTRIAL APPLICABILITY

The stereo signal converting apparatus, stereo signal inverse-converting apparatus and converting and inverse-converting methods of the present invention are suitably used for mobile phones, IP telephones and television conference, and so on.

1. A stereo signal converting apparatus comprising:
an analyzing section that analyzes a timing difference at which a correlation between a first channel signal and second channel signal forming a stereo signal is highest;
a sliding section that moves the second channel signal temporally based on the timing difference; and
a sum and difference calculating section that generates a monaural signal related to a sum of the first channel signal and the temporally-moved second channel signal, and generates a side signal related to a difference between the first channel signal and the temporally-moved second channel signal.

2. The stereo signal converting apparatus according to claim 1, further comprising a move value calculating section that calculates a move value of a current frame based on a value by which the second channel signal was moved in a previous frame and the timing difference,
wherein the sliding section moves the second channel signal temporally by the move value of the current frame.

3. The stereo signal converting apparatus according to claim 2, wherein the move value calculating section:
matches the move value of the current frame with a move value of the previous frame when the timing difference is equal to the value by which the second channel signal was moved in the previous frame;
increases the move value of the current frame by a predetermined amount from the move value of the previous frame when the timing difference is greater than the value by which the second channel signal was moved in the previous frame; and
decreases the move value of the current frame by a predetermined amount from the move value of the previous frame when the timing difference is less than the value by which the second channel signal was moved in the previous frame.

4. An encoding apparatus comprising:
the stereo signal converting apparatus according to claim 1;
a first encoding section that encodes the monaural signal generated in the stereo signal converting apparatus;
a second encoding section that encodes the side signal generated in the stereo signal converting apparatus; and
a third encoding section that encodes information indicating a value by which the second channel signal was moved in the stereo signal converting apparatus.

5. A stereo signal inverse-converting apparatus comprising:
a reconstructed signal generating section that generates a reconstructed signal of a first channel signal and a reconstructed signal of a temporally-moved second channel signal, using a reconstructed monaural signal and a reconstructed side signal, the reconstructed monaural signal being acquired by decoding encoded data of a monaural signal related to a sum of the first channel signal and the temporally-moved second channel signal forming a stereo signal, and the reconstructed side signal being acquired by decoding encoded data of a side signal related to a difference between the first channel signal and the temporally-moved second channel signal; and
a opposite-sliding section that moves and corrects the reconstructed signal of the temporally-moved second channel signal.

6. The stereo signal inverse-converting apparatus according to claim 5, further comprising an interpolating section that, when a blank area occurs in a signal sequence of the reconstructed signal of the second channel signal as a result of moving the reconstructed signal of the second channel signal in the opposite-sliding section, interpolates the blank area.

7. The stereo signal inverse-converting apparatus according to claim 5, further comprising an overlap area processing section that, when an overlap area occurs in a signal sequence of the reconstructed signal of the second channel signal as a result of moving the reconstructed signal of the second channel signal in the opposite-sliding section, resolves an overlap in the overlap area by performing a predetermined calculation using the reconstructed signal of the second channel signal in the overlap area.

8. A decoding apparatus comprising:
a first decoding section that decodes encoded data of a monaural signal and generates a reconstructed monaural signal;
a second decoding section that decodes encoded data of a side signal and generates a reconstructed side signal;
a third decoding section that decodes encoded data of information indicating a value by which a second channel signal was moved; and
the stereo signal inverse-converting apparatus according to claim 5.

9. A stereo signal converting method comprising:
an analyzing step of analyzing a timing difference at which a correlation between a first channel signal and second channel signal forming a stereo signal is highest;
a sliding step of moving the second channel signal temporally based on the timing difference; and
a sum and difference calculating step of generating a monaural signal related to a sum of the first channel signal and the temporally-moved second channel signal, and generating a side signal related to a difference between the first channel signal and the temporally-moved second channel signal.

10. A stereo signal inverse-converting method comprising:
a reconstructed signal generating step of generating a reconstructed signal of a first channel signal and a reconstructed signal of a temporally-moved second channel signal, using a reconstructed monaural signal and a reconstructed side signal, the reconstructed monaural signal being acquired by decoding encoded data of a monaural signal related to a sum of the first channel signal and the temporally-moved second channel signal forming a stereo signal, and the reconstructed side signal being acquired by decoding encoded data of a side signal related to a difference between the first channel signal and the temporally-moved second channel signal; and
a opposite-sliding step of moving and correcting the reconstructed signal of the temporally-moved second channel signal.
